(19) United States
(12) Patent Application Publication
(10) Pub. No.: US 2025/0191561 A1
(43) Pub. Date: Jun. 12, 2025

(54) SONGS AND PRODUCTION METHOD THEREOF

(71) Applicant: Dr. NakaMats Innovation Institute, Tokyo (JP)

(72) Inventor: Yoshiro NakaMats, Tokyo (JP)

(21) Appl. No.: 18/976,877

(22) Filed: Dec. 11, 2024

(30) Foreign Application Priority Data
Dec. 11, 2023 (JP) 2023-208891

(51) Int. Cl. G10H 1/00

(52) U.S. Cl. CPC G10H 1/0025; G10H 2210/125

(57) ABSTRACT

Most of the songs were lyrics such as the relationship between men and women, love, landscapes such as mountains, rivers, and moons, and there were few lyrics with principled theories and educational content that could be used for all kinds of education, schools, social education, children's education, etc., and were accepted in any field and became a source of life.

Solution: A song composition method characterized by the fact that there is a concatenator between the first and second songs, there is a general description before the first song, and the whole is formed by combining these four.

### TECHNICAL FIELD

The present invention relates to a song and a method for producing a song.

### BACKGROUND TECHNOLOGY

Although various songs have been made so far, this invention is an invention of a method of composing a song that is completely different from a conventional song and the content of the song.

### OUTLINE OF THE INVENTION

### Problems to be Solved by the Invention

A conventional song is just a song and is sung in a song program, etc., but it has no educational effect and belongs to the so-called entertainment and creative fields, but the present invention is not so, it is an education or a way of thinking, and the composition of the song is also conventionally composed by mere emotion, but the present invention is logically composed based on a completely different idea.

Conventionally, most of the songs have lyrics such as relationships between men and women, love, landscapes such as mountains, rivers, moons, etc., and it is a song or creation method that is bound by a single song or genre, and can be used for various education, schools, social education, children's education, etc. There were few lyrics that were accepted by any field and had a fundamental or educational content that would feed their lives.

### Measures to Solve the Problem

The present invention that solves the above problem is an invention of a new method of constructing a song and the content of a song. Specifically, there is a conjugator between the first and second songs that binds the first and second songs, and there is a comprehensive explanatory term before the first song, and the four are combined to form a whole.

The lyric part of the description of the song, the part of the old melody known by all, the part of the lyrics that serves as a connection between the melodies, the part of the old melody that everyone knows, the melody and the lyric composition, the combination of multiple melodies, the song and its production method.

### Effect of the Invention

Unlike conventional songs, it is not simply a song that celebrities can sing or watch a TV singing program, but of course it can be done, but in addition to that, it is a completely different song that is used for education, school, social education, children's education, and everything. It is a song with a different structure.

### BRIEF DESCRIPTION OF THE DRAWING

FIG. 1 is a diagram showing a known song and a method of producing a song.

FIG. 2 is a first embodiment of the present invention and is a view showing an overall configuration.

FIG. 3 is a second embodiment of the present invention and is a diagram showing a configuration and production method.

FIG. 4 shows an example of production and recording according to the second embodiment of the present invention.

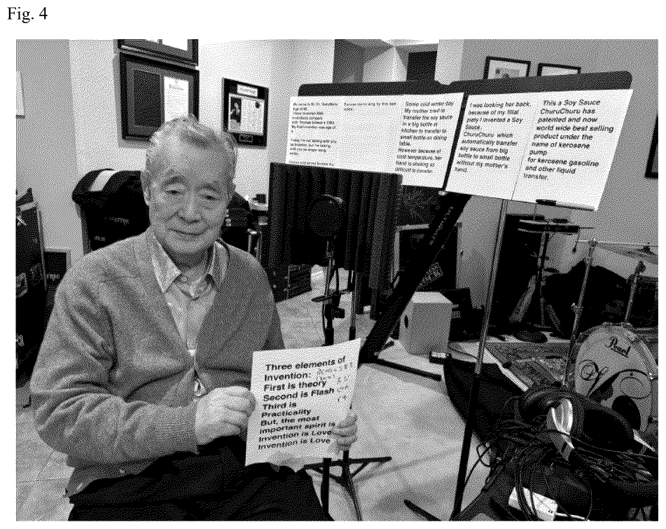

### EMBODIMENT FOR IMPLEMENTING THE INVENTION

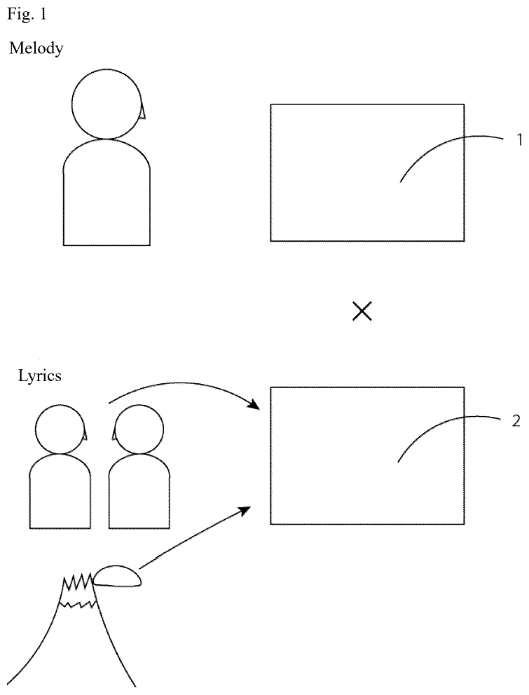

FIG. 1 is a diagram illustrating a known song and a method of producing a song.

A melody (song) is a song based on the sound that the composer has in mind. Most of the lyrics are about men and women, love, mountains, rivers, moons, landscapes, etc. Then, as described in FIG. 1, the melody and lyrics are multiplied to form a song.

In this case, it is a song or a method of creation that is bound by a single song or genre, and preferences arise.

There are very few lyrics that can be used in various education, schools, social education, children's education, etc., and are accepted in any field and are a source of life.

### First Embodiment of the Present Invention

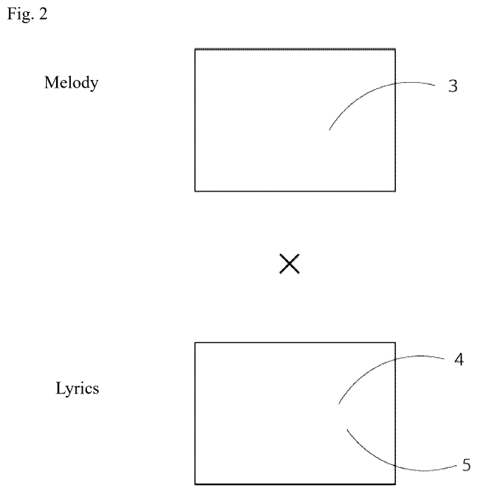

FIG. 2 is a diagram illustrating a first embodiment of the present invention and is characterized by a melody and lyrics composition. The melody is something that everyone knows. Therefore, it is good to have a song that has been sung for a long time.

Since there is a problem of copyright infringement, it is better to use a melody whose copyright has expired or a melody that has been dealt with such as a license agreement. It is preferable to have a melody that has been sung for more than 70 years since the death of the author and that everyone is familiar with.

The lyrics are not emotionally themed as is known, but are lyrics of principles or theories and/or educational content.

In this way, the melody and lyrics are multiplied to form the invention song.

According to the first embodiment of the present invention, since it is a melody that everyone knows, it is easy to remember, and its content is a song of principle or theory and/or educational content, so it becomes a life experience.

### Second Embodiment of the Invention

The second embodiment of the present invention is as shown in FIG. 2, and there is a first melody 7 and a second melody 9, and a lyric 8 that serves as a conjunction between the first and second melodies that combine the first and second melodies.

Specifically, I will explain in order.

The first structure is lyric 6, which explains the structure of the entire song. Next, the second composition is a composition 7 based on, for example, an A melody (song, melody) known to everyone in composer 1. The next third configuration 8 is the lyric 8 of the conjugator portion that combines the A melody configuration 7 and the fourth B melody configuration 9. For example, if the fourth composition is the same as the second composition, for example, if it is Beethoven, it is a different Beethoven piece, and if the second composition is Beethoven's “Fifth”, for example, the fourth composition is Beethoven's “Ninth”. Also, for example, there are cases where the song is different by a German author. There are also cases where the composer is completely different, for example, the composition of No. 2 is Schubert, the composition of No. 4 is Chopin, and so on.

The reason for such a composition is that, firstly, since the present invention is a completely different song, the commentary is the first, the explanation is given in the first place in order to understand the song, and the second is the melody song of the first song, which is the basic purpose of the book, the song, in sentences, like grooming, like a summary, It is a lyric music that expresses it.

Next, the third structure is an explanation for connecting the A melody (song) and the B melody (song), for example, in the case of lyrics that say that the invention is an idea in A melody (song), the B melody (song) is a method of composition that says the idea and a specific example.

For example, in the third configuration, on a cold winter day, my mother tried to move a large bottle of soy sauce to the small tabletop soy sauce on the table, but it was too cold to move it because her hands were biting. Seeing my mother's back, I wanted to make her feel comfortable with my filial piety, so I invented a bottle of soy sauce that automatically flowed into the soy sauce on the tabletop. The name of this invention is soy sauce churuchuru, or to be precise, it is a kerosene pump, which is registered with the Japan Patent Office, and it was invented when I was 14 years old. This explanation is the composition of No. 3, and it leads to the next composition of No. 4.

The fourth composition is completely different from the composition of the first one, and the melody (song) B is played. In order to explain in more detail what invention is like the structure of No. 4, I select a song that can be explained in detail, such as Schubert's “Trout” or Beethoven's “Ninth,” rather than a song that can be explained in detail, and combine it as the composition of No. 4. It is the present invention to produce songs and music by such a method.

There are three elements to an invention. The first is theory. This is called a streak. In short, there are three elements: streaks, pica, and iki, and streaks are theories. Pica is an epiphany. Iki is practicality. These three elements are necessary for invention, but what is even more important is the heart of love. As mentioned above, kerosene pumps are made out of love for mothers, that is, filial piety, and this is spread all over the world, not only in Japan, but all over the world. It was a blockbuster invention. Such an explanation is given in the B melody (song), that is, the fourth composition.

This completes the whole song, and the person who sings it and the listener sings the point that the most important point is that “invention is love” is the most important point, which no one has ever said. And this is educational, that is, education for society, whether it is education for schools or children, and it is the invention of a song that has such educational merits, and it is an invention of a song that is completely different from the usual songs, such as falling in love, beautiful scenery, and the wind blowing.

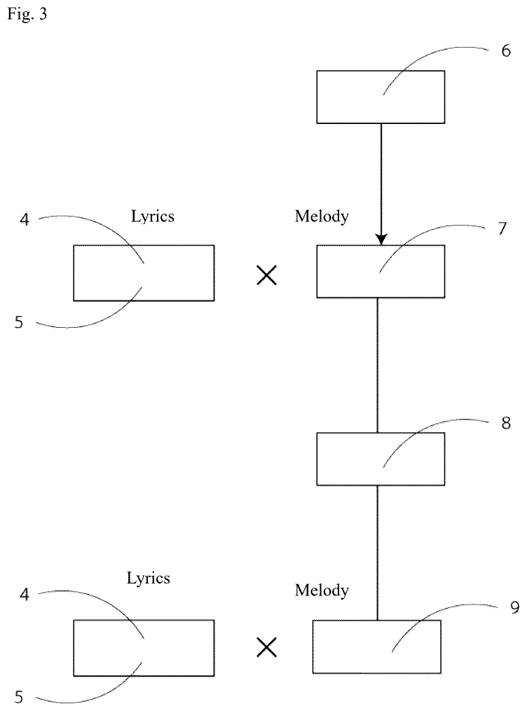

FIG. 3 shows the actual recording situation of the second embodiment of the present invention.

The lyrics listed from the upper right to the upper center are examples of the creation of the second A melody, the first composition, and the third structure, and the lower center shows an example of the creation of the fourth B melody.

In the present invention, the method of producing a song, and the song and music are performed in a theoretical construction and are different from creation.

### INDUSTRIAL APPLICABILITY

This song can be used effectively for schools, children's education, and social education, and it is completely different from a mere play song, a love song, or a landscape song. And this creates an industrial effect.

### EXPLANATION OF THE CODE

1 A new melody that came out of the composer's head.
2 Lyrics for men and women, love, mountains, rivers, moons, landscapes, etc.
3 With a melody that every person knows,
   Moreover, the copyright has expired
4 The Principle of Things, Seori
5 Educational content
6 Song description lines
7 Melody A that everyone knows
8 Explanation of the connection that binds them together
9 Melody B that everyone knows
(Same composer as Melody A or different composer)

1. A song composition method characterized by the fact that there is a concatenator between the first and second songs that combine the first and second songs, and there is a comprehensive explanatory term before the first song, and that the whole is formed by combining these four.

2. The content of the song is not love or scenery or anything like that, but it is a song that has lyrical content that becomes educational, principled, and theoretical, such as the theory of invention, its necessary elements, and the necessary mind.
